(19) United States
(12) Patent Application Publication
(10) Pub. No.: US 2018/0111742 A1
(43) Pub. Date: Apr. 26, 2018

(54) Device and Method of Heating Potstickers by Microwave

(71) Applicant: Jing-Yau Chung, Houston, TX (US)

(72) Inventor: Jing-Yau Chung, Houston, TX (US)

(21) Appl. No.: 15/793,672

(22) Filed: Oct. 25, 2017

Related U.S. Application Data
(60) Provisional application No. 62/412,357, filed on Oct. 25, 2016.

(51) Int. Cl. B65D 81/34; A21D 13/31

(52) U.S. Cl. CPC B65D 81/3461; B65D 2581/3455; A21D 13/31

(57) ABSTRACT

The disclosure relates to an apparatus for preparation of a potsticker food product, having: a bag; the potsticker food product within the bag; and wherein the bag defines at least one air gap through the bag. The disclosure further relates to a potsticker manufacturing process, having the steps of: placing a potsticker food product in a bag; sealing the bag; and creating at least one air gap through the bag. Additionally, the disclosure relates to a potsticker preparation process, having the steps of: microwaving a potsticker food product in a bag to create steam; and steaming and venting the steam through at least one air gap through the bag.

### STATEMENTS REGARDING FEDERALLY SPONSORED RESEARCH OR DEVELOPMENT

Not Applicable.

### NAMES OF THE PARTIES TO A JOINT RESEARCH AGREEMENT

Not Applicable.

### BACKGROUND

In recent years, the Asian style dumpling, also known as potsticker has gained its popularity in the U.S. consumer markets. It is well known that in preparing potstickers, it takes substantial amount of time to cook or even to heat up potstickers by all existing methods. There has not been a satisfactory method of preparing potstickers by microwave heating, even though microwave heating is commonly accepted as a convenient, efficient and desirable heating method. So far, applying microwave heating based on the heating instructions provided for the packaged potsticker food products in the market often results in unsatisfactory outcomes with common problems of overheating or insufficient heating. The typical result of over-heating the potstickers with microwave is a severe dehydration of the potsticker skin that greatly deteriorates the food quality. The main reason that an existing microwave heating method does not apply to potstickers is that the potsticker skin is relatively more sensitive to microwave heating.

### BRIEF SUMMARY

The current disclosure relates to a new device and method of heating potstickers with microwave(s) that gives or results in consistent good quality potstickers after heating, therefore it is a useful new tool for microwave heating of commercial packaged potsticker food products.

The disclosure relates to an apparatus for preparation of a potsticker food product, having: a bag; the potsticker food product within the bag; and wherein the bag defines at least one air gap through the bag. The disclosure further relates to a potsticker manufacturing process, having the steps of: placing a potsticker food product in a bag; sealing the bag; and creating at least one air gap through the bag. Additionally, the disclosure relates to a potsticker preparation process, having the steps of: microwaving a potsticker food product in a bag to create steam; and steaming and venting the steam through at least one air gap through the bag.

### BRIEF DESCRIPTION OF THE DRAWING(S)

The exemplary embodiments may be better understood, and numerous objects, features, and advantages made apparent to those skilled in the art by referencing the accompanying drawing(s). These drawing(s) are used to illustrate only exemplary embodiments, and are not to be considered limiting of its scope, for the disclosure may admit to other equally effective exemplary embodiments. The figures are not necessarily to scale and certain features and certain views of the figures may be shown exaggerated in scale or in schematic in the interest of clarity and conciseness.

FIG. 1 depicts a schematic view of potstickers in a bag according to an exemplary embodiment of the improvements disclosed herein.

### DESCRIPTION OF EMBODIMENT(S)

The description that follows includes exemplary apparatus, methods, techniques, and instruction sequences that embody techniques of the inventive subject matter. However, it is understood that the described embodiments may be practiced without these specific details.

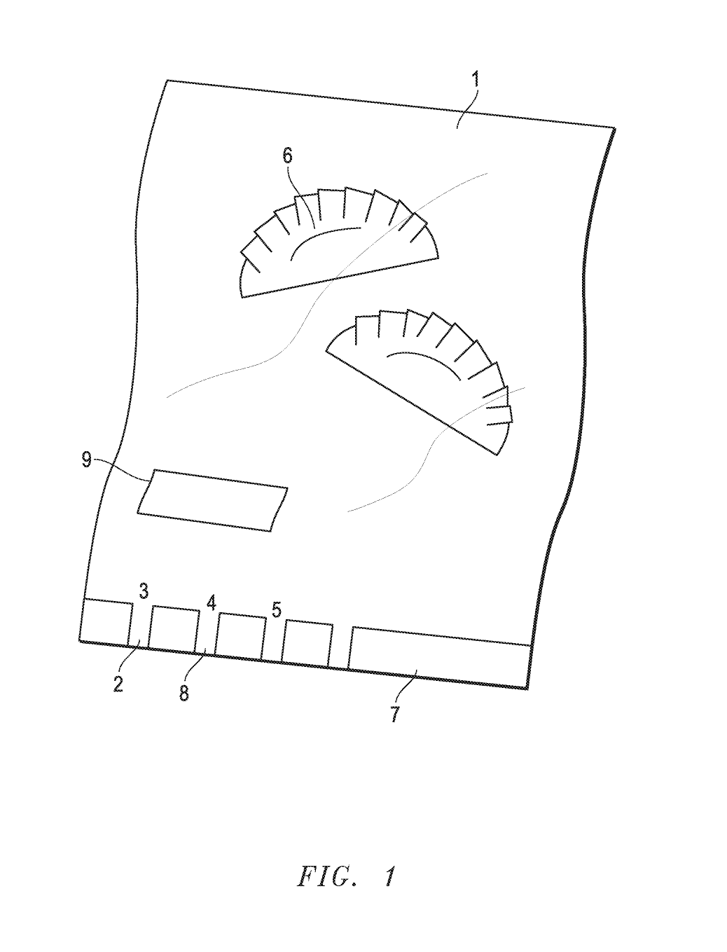

With reference to FIG. 1, the current invention consists of Bag 1 which is made of microwavable material. A number of breathing/breathable Air Gap(s) 2 are built on the Bag Seal 7 of Bag 1 such that the air inside Bag 1 can only be breathed out of the bag through Air Gap(s) 2 at locations, for example 3, 4 and 5. At each of locations 3, 4 and 5, there is an unsealed short Section 8 with an unsealed length of, for example five millimeters that constitute(s) the breathing Air Gap 2 on Bag Seal 7. As depicted in FIG. 1, Frozen Potsticker(s) 6 being sealed in Bag 1 with breathing Air Gap(s) 2 is subject to microwave heating. For a given size of Bag 1, the number and the size of the breathing Air Gap(s) 2 are chosen for a given Frozen Potsticker(S) 6 for the purpose of an optimum microwave heating result. Steam resulting from microwave heating may vent via the breathing Air Gap(s) 2. An optimum microwave heating result refers to an optimum food quality after a given length of microwave heating. Examples of the applications of the current invention are for two types of frozen potsticker food product to be packaged by the current author's company, namely (1) 6 to 7 oz. frozen potsticker packed in a microwavable bag with or without sauce packet included in the bag and (2) 7 to 8 oz. frozen potsticker packed in a microwavable bag with or without sauce packet 9 included in the bag.

For the above mentioned packaged frozen food products, the current invention uses the following configuration and parameters:

(1) Frozen potsticker packed with or without sauce packet 9 in a 6 to 7 oz. microwavable bag:
(a) Length of Section 8 of Air Gap(s) 2 is 4 millimeters to 5 millimeters.
(b) Number of locations of breathing Air Gap(s) 2 is three (3).
(c) Length of microwave heating time is 1 minute 30 seconds to 1 minute 35 seconds at medium heat level setting.

(2) Frozen potsticker packed with or without sauce packet 9 in a 7 to 8 oz. microwavable bag:
(a) Length of Section 8 of Air Gap(s) 2 is 4 millimeters to 5 millimeters.
(b) Number of locations of breathing Air Gap(s) 2 is four (4).
(c) Length of microwave heating time is 1 minute 50 seconds to 2 minutes at medium heat level setting.

In other exemplary embodiments the size of the Air Gap(s) 2 (or the length of Section 8) may vary, the number of the locations of the Air Gap(s) 2 may vary, the placement of the locations of the Air Gap(s) 2 may vary, and/or the microwave heating time and/or intensity/power may vary. A sealing device may be used to create the Bag Seal 7 of Bag 1 together with Air Gap(s) 2 at locations, for example, 3, 4 and 5. In another working exemplary embodiment, the placement of the locations of the Air Gap(s) 2 may appear some or all in regions of the Bag 1 other than the Bag Seal 7 (e.g. some or all as perforations through the sidewalls of the Bag 1). The length of the Section 8 of Air Gap(s) 2 and the length of the microwave heating time may be collectively and/or separately critical to the preferred success of the final potsticker food product 6 for the purpose of achieving optimal food quality within the context of the size of the bag 1.

While the embodiments are described with reference to various implementations and exploitations, it will be understood that these embodiments are illustrative and that the scope of the inventive subject matter is not limited to them. Many variations, modifications, additions and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. An apparatus for preparation of a potsticker food product, comprising:
a bag;
the potsticker food product within the bag;
and
wherein the bag defines at least one air gap through the bag.

2. The apparatus of claim 1, wherein the bag has a bag seal.

3. The apparatus of claim 2, wherein the at least one air gap is defined through the bag seal.

4. The apparatus of claim 3, wherein the at least one air gap has a length of 4 millimeters to 5 millimeters.

5. The apparatus of claim 4, wherein the at least one air gap is comprised of three to four air gaps.

6. The apparatus of claim 5, wherein the bag comprises a 6 to 8 oz. microwavable bag.

7. The apparatus of claim 6, further comprising a sauce packet.

8. The apparatus of claim 7, wherein the potsticker food product is frozen.

9. The apparatus of claim 6, wherein the microwavable bag comprises a 6 to 7 oz. microwavable bag and the air gaps comprise three air gaps.

10. The apparatus of claim 6, wherein the microwavable bag comprises a 7 to 8 oz. microwavable bag and the air gaps comprises four air gaps.

11. A potsticker manufacturing process, comprising the steps of:
placing a potsticker food product in a bag;
sealing the bag; and
creating at least one air gap through the bag.

12. The process of claim 11, wherein the step of creating at least one air gap through the bag is performed during the step of sealing the bag.

13. The process of claim 11, further comprising the step of freezing the potsticker food product.

14. The process of claim 12, wherein the step of creating at least one air gap through the bag comprises creating three to four air gaps through the bag each having a length of 4 millimeters to 5 millimeters.

15. A potsticker preparation process, comprising the steps of:
microwaving a potsticker food product in a bag to create steam; and
steaming and venting the steam through at least one air gap through the bag.

16. The process of claim 15, wherein the step of microwaving the potsticker food product in a bag to create steam comprises microwaving the potsticker food product for a length of time from 1 minute 30 seconds to 2 minutes.

17. The process of claim 16, wherein the step of microwaving the potsticker food product is performed at a medium heat level setting of a microwave.

18. The process of claim 17, where in the step of steaming and venting the steam through at least one air gap through the bag comprises steaming and venting the steam through three to four air gaps through the bag each having a length of 4 millimeters to 5 millimeters.

19. The process of claim 18, wherein the step of microwaving the potsticker food product comprises microwaving the posticker food product for the length of time from 1 minute 30 seconds to 1 minute 35 seconds, and wherein the bag is a 6 to 7 oz. microwavable bag.

20. The process of claim 18, wherein the step of microwaving the potsticker food product comprises microwaving the posticker food product for the length of time from 1 minute 50 seconds to 2 minutes, and wherein the bag is a 7 to 8 oz. microwavable bag.
